(19) United States
(12) Patent Application Publication
(10) Pub. No.: US 2012/0297759 A1
(43) Pub. Date: Nov. 29, 2012

(54) System of power generation with under water pressure of air

(76) Inventor: Chui Wen Chiu, Branchton (CA)

(21) Appl. No.: 13/067,373

(22) Filed: May 27, 2011

(51) Int. Cl. F15B 3/00

(52) U.S. Cl. 60/398

(57) ABSTRACT

Higher pressure exists at the bottom of deep water (including other fluids). This system utilizes machinery to compress a compressible fluid matter such as air with deep water high pressure so as to store the energy in the compressed air having a smaller compressed volume. The compressed air is subsequently injected into an expansion chamber in which it releases the stored energy and returns to its original volume. In constant temperature, a 10 m³ volume of water provides 10 times pressure to compress a single volume to 1/10 its volume. When the pressure is reduced 10 times, the compressed air would return to its original volume to release the stored energy which can be utilized to rotate a turbine and in turn a power generator to generate electric power.

### BACKGROUND OF THE INVENTION

A volume of a cubic meter of water weighs one ton so that water flowing downward from a high elevation to a lower level can provide a very high pressure which can be utilized to generate hydroelectric power such as from a water dam. However, once it has reached the lower level, it can no longer be utilized, since it can not flow backward to the high elevation. The present invention provides a system which generates a water flow upward to create a cost free high pressure air in the system. It temporarily stores energy in water pressure by using it to compress a volume of air. The compressed air is subsequently injected into a low pressure environment such that it would recover to its original uncompressed state. The recovery inherently release the compressed energy which can be utilized to turn a generator or the propeller mounted on a power generator shaft to provide electric power output. The released energy may also be utilized to enable a fire truck in providing a high pressure water stream in fire extinguishing particularly for fire in a tall building, or for other applications in which a high pressure is required. The system thus generates green energy which does not produce any harmful matters to the environment and has valuable economical benefits.

### SUMMARY OF THE INVENTION

The principal object of the present invention is to provide an electric power generation system installed in a high-rise water located in great depth under water. As water pressure is calculated with the mass by acceleration due to gravity multiply by its weight, velocity and height (namely depth of the water), and since mass, weight and acceleration are constant, the water pressure at any depth is solely dependent on the depth of the water, which determines the capacity of the system. Therefore, in order to obtain maximum power generation capacity, it would ordinarily be necessary to fabricate the system of the present invention several hundred feet under water. However, since human workers are unable to survive and work in such deep location under water, I have moved the water pressure above, and have installed pressure transmitters on the floor of a high-rise water located above the head of the workers. A plurality of pressure transmitters surround a central operating tube. The pressure transmitters sequentially inject water and high pressure compressed air alternately into the central operating tube to provide high pressure for rotating a turbine which is connected to a power generator for generating electric power. It may also be directly utilized to provide the high pressure for delivering fire extinguishing water in fire-fighting for a tall building.

### BRIEF DESCRIPTION OF THE DRAWINGS

FIG. 1 is a vertical partial sectional front elevation view of an exemplary embodiment of the under water system of the present invention having two pressure transmitters.

FIG. 2 is a partial sectional front elevation view of the underground installations including the power generator, the water storage tank, water extracting device, and air supply system, located below the pressure transmitters.

FIG. 3 is a vertical partial sectional overall front elevation view of the system of the present invention.

FIG. 4 is a top elevation view of the system of the present invention along section line x-x of FIG. 3 showing an exemplary embodiment having eight pressure transmitters surrounding the central operation tube for injecting high pressure air to rotate the turbine.

FIG. 5 shows sectional side elevation view along various sections of the capillary tube of the system of the present invention for raising the high pressure water and air to a high elevation.

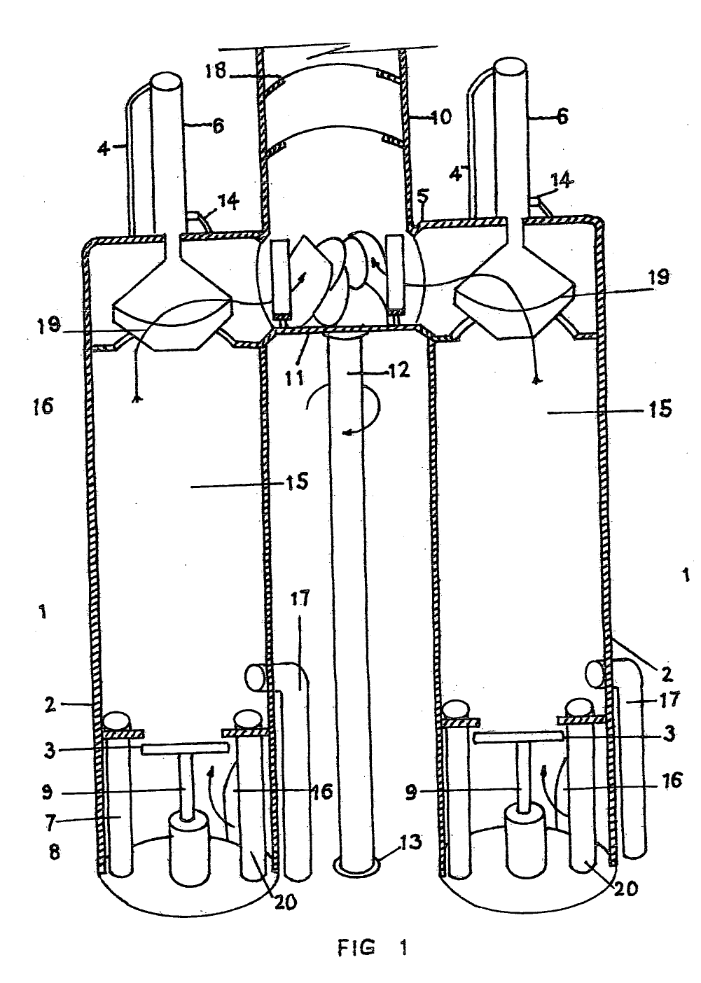

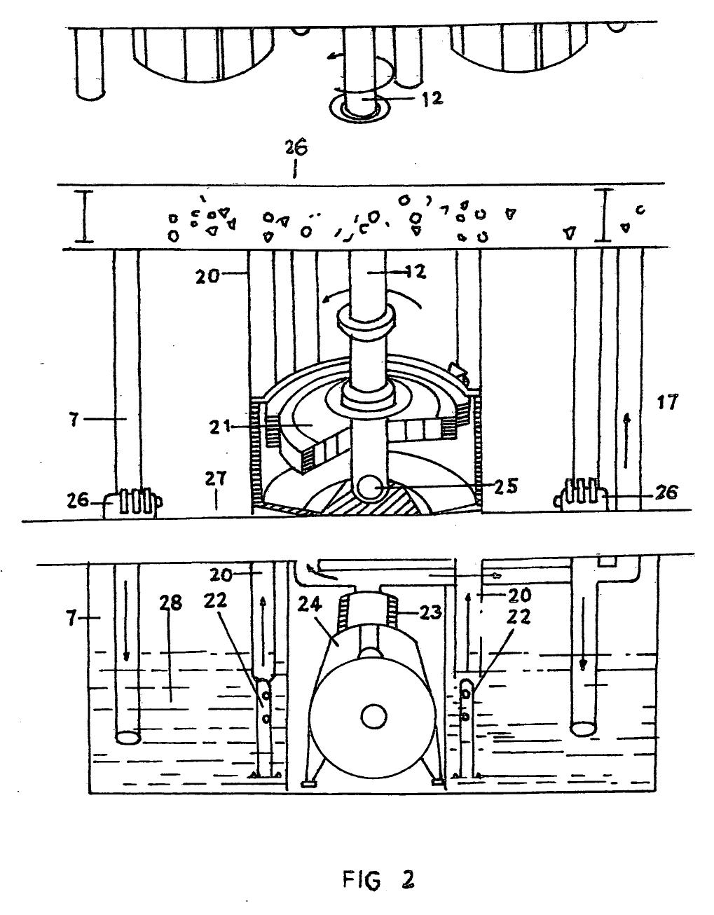

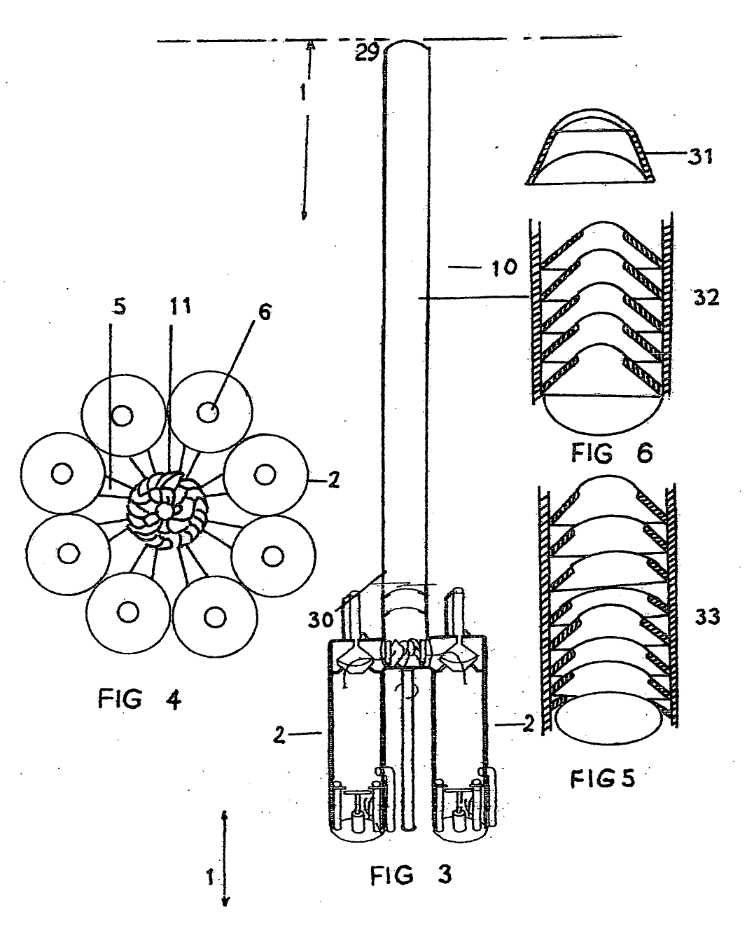

### DETAILED DESCRIPTION OF THE PREFERRED EMBODIMENT

With reference to the drawings, the items indicated by the reference numerals are as follows:

1. Water: it is stored in a high-rise water.

2. Pressure transmitter: it utilizes water pressure for compressing air to store pressure in the compressed air.

3. Lower check valve: it is located at the lower portion of the pressure transmitter.

4. Pneumatic oil conducting pipe: it is for delivering pneumatic oil to the reciprocating pump for operating the check valves up and down.

5. Channel which is located between the pressure transmitter and the turbine.

6. Pneumatic pump for operating the upper check valve open or close.

7. Downward draining pipe.

8. Lower pressure oil pump for operating the lower check valve open or close.

9. Reciprocating rod.

10. Elongated pipe extending from bottom of water to the water upper surface for raising water with high pressure air upward to cause water bottom high pressure for turning the turbine and in turn rotating the power generator.

11. Turbine for turning the main rotary shaft to rotate the power generator.

12. Main rotary shaft.

13. High strength leak-proof bearing.

14. Reciprocation of pressure oil pump tube.

15. Compressing chamber of pressure transmitter, utilizing high pressure from water to produce valuable compressed air without cost and can subsequently release its stored energy.

16. Inlet port to the pressure transmitter to supply recycled water into the pressure transmitter.

17. 1.5 high air pressure, higher than pressure in the compression chamber for increasing the flowing speed in the compression chamber.

18. Capillary characteristic as shown in cross sections 31, 32 or 33.

19. Check valve.

20. Water pipe for recycling water into the compression chamber of the pressure transmitter: It is controlled by an electromagnetic open and close mechanism and can operate without effort for recycling the amount of water released in the expansion chamber by the pressure transmitter after injecting the compressed air into the expansion chamber to a spent water storage pool back to the compression chamber.

21. Electric power generator.

22. Water pump.

23. Low capacity compressor: used for increasing velocity of the air for inputting to the compression chamber.

24. Air storage tank.

25. Rotary shaft support bearing.

26. Water pump motor: Every time prior to injecting compressed air, a portion of the water in the compression chamber must be extracted to provide a space for air. However, the amount of water extracted must be returned into the pressure transmitter to maintain the water volume in the high-rise water.

27. Floor of the ground.

28. Spent water storage pool.

29. Water upper surface.

30. Sky tube: a tube for releasing water pressure with pressured air. It has capillary characteristics within the tube. Water rises upward in the tube because the density of the mixture of compressed air and water is lighter than stored water in the high-rise water.

31. Construction of the trumpet-shaped diaphragm of the capillary tube.

32. A characteristic of the capillary tube.

33. Other characteristics of the capillary tube.

The operation of the pressure transmitters are electrically controlled such as by a computer located in a control room situated in a lower storey chamber in the high-rise water under water. The computer regulates the operation of the two check valves and three open and shut ports to create alternate low and high pressure environments within the pressure transmitters so as to provide compressed air with high pressure for expelling water. More importantly, only low electric power is required for operating the electric motor to initiate the water expelling power as well as recycling the water in the system.

The computer automatically executes the following sequential operation steps of the pressure transmitter:

1. Close the upper and lower check valves and the three open and shut ports;
2. Open the water inlet port at the bottom of the pressure transmitter, and open the upper and lower check valves, so that water enters into the pressure transmitter to fill the pressure transmitter chamber partially to about 5 meters high;
3. Close both the upper and lower check valves;
4. Open the water release port and the air inlet port until within 15 meters of the pressure transmitter chamber is filled with 5 meters of water and 10 meters of air;
5. Close the water release port and the air inlet port so that the compression chamber is completed isolated;
6. Open the water inlet port and the lower check valve such that the high pressure water at the great depth enters the compression chamber to compress the air therein to a smaller volume to become a high pressure air;
7. Open the upper check valve to inject the high pressure air with pressured water to rotate the turbine which, in turn, rotate the power generator for generating the electric power. The high pressure air is sequentially injected into the central operation tube from the plurality of pressure transmitters for rotating the turbine;
8. Turn on the water pump to draw the water from a spent water storage pool back into the pressure transmitters which is in a low pressure environment since the water released from the pressure transmitters must be equal the quantity of water required to refill the high-rise water in order to achieve the recycle;
9. Again close all the check valves and water inlet and outlet ports of the pressure transmitter having completed steps 1 to 9; and
10. Repeat steps 1 to 9 this pressure transmitter to provide power generation. Thus, all pressure transmitters are sequentially operated to provide green power generation from the system.

What I claimed is:

1. A power generation system comprising,
locating a plurality of pressure transmitters in deep water,
providing an initial predetermined amount of air in a compression chamber in said pressure transmitters,
inputting high pressure water from said deep water into said compression chamber to compress said air to a high pressure compressed air,
injecting said high pressure compressed air into an expansion chamber having a turbine, for rotating said turbine by energy released from said compressed air in said expansion chamber, and in turn, turning an electric generator for generating electric power,
directing said compressed air mixed with water to rise upward of an elongated tube to upper surface level of said deep water, said compressed air mixed with water being usable for a variety of applications including, firefighting and recycling between a water storage tower and lower water storage pool to generate electric power from flow of said water content through a water wheel.

2. A power generation system according to claim 1 including providing a water inlet port located at a bottom portion of each pressure transmitter of said pressure transmitters for inputting high pressure water from said deep water into said compression chamber to compress a predetermined amount of initial air within said compression chamber to create a mixture of compressed air and water, and injecting said mixture of compressed air and water from said compressed chamber into said expansion chamber.

3. A power generation system according to claim 1 wherein said compression chamber is located between a lower check valve operative for inputting said high pressure water into said compression chamber, and an upper check valve operative for injecting said compressed air mixed with water into said expansion chamber.

4. A power generation system according to claim 1 wherein said pressure transmitter is provided with a water draining port, a water inlet port, and an air inlet port, all in communication between said compress chamber of said pressure transmitter and an operating room located below the water bed.

5. A power generation system according to claim 1 wherein said plurality of pressure transmitters are located in a surrounding manner around said expansion chamber and are operative to inject said mixture of compressed air and water sequentially into expansion chamber to rotate said turbine.

6. A power generation system according to claim 1 including a plurality of power generation units having a plurality of pressure transmitters surrounding a plurality of individual expansion chamber with a turbine provided in each one of said expansion chambers.

7. A power generation system according to claim 1 wherein said system is installable in water including sea, lake and water well, and provides a safe environment on land in a building for workers to operate said system away from high pressure environment on the surface in building.

8. A power generation system according to claim 5 including provision of a capillary tube above said expansion chamber for delivering said mixture of compress air and water to a high elevation for extinguishing fire in firefighting.

9. A power generation system according to claim 1 including recycling water below a hydro water dam back to above said water dam.

10. A power generation system according to claim 1 including locating said system in a ship for providing propelling power for the ship.

11. A power generation system according to claim 1 characterized by utilizing high pressure water to compress air to provide a high pressure air.

12. A power generation system according to claim 1 wherein said high pressure includes pressure from a large body of fluid.
